(19) United States
(12) Patent Application Publication
(10) Pub. No.: US 2013/0059150 A1
(43) Pub. Date: Mar. 7, 2013

(54) METHOD OF MANUFACTURE FOR HOLLOW FIBRE CERAMIC MEMBRANE

(71) Applicants: Joao Carlos Diniz Da Costa, Toowong (AU); Adrian Chin-Han Leo, Indoorooilly (AU); Shaomin Liu, Canning Vale (AU)

(72) Inventors: Joao Carlos Diniz Da Costa, Toowong (AU); Adrian Chin-Han Leo, Indoorooilly (AU); Shaomin Liu, Canning Vale (AU)

(73) Assignee: THE UNIVERSITY OF QUEENSLAND, St. Lucia, Queensland (AU)

(21) Appl. No.: 13/579,679

(22) PCT Filed: Feb. 17, 2011
(86) PCT No.: PCT/AU2011/000167

§ 371 Date: Nov. 5, 2012

(30) Foreign Application Priority Data
Feb. 17, 2010 (AU) 2010900646

(51) Int. Cl. B29B 9/12; B01D 71/02; C04B 35/01

(52) U.S. Cl. 428/398; 264/8

(57) ABSTRACT

A process for producing a ceramic membrane in the form of a hollow fibre, which process comprises: forming a suspension by mixing inorganic oxide precursor particles with a solution of a polymer binder dissolved in a solvent for the binder; feeding the suspension through a spinneret to form hollow fibres; passing the fibres through an air gap and into a coagulant to solidify the fibres; heating the fibres to remove the polymer binder; and sintering the fibres to render them gas tight, wherein the polymer binder is selected so that it may be removed from the fibres by heating without leaving any residual species within the ceramic that will impair the oxygen permeability of the fibres.

### FIELD OF INVENTION

The present invention relates to the production of gas tight ceramic hollow fibres. More specifically, the present invention relates to the production of gas tight ceramic hollow fibres that exhibit improved oxygen permeability when compared with hollow fibres reported previously. The present invention also relates to certain gas tight ceramic hollow fibres per se.

### BACKGROUND TO INVENTION

Ceramic membranes of mixed ionic-electronic conductivity are useful for high-temperature air separation and for a variety of chemical reactions involving oxygen as a reactant. For example, perovskite membranes have been prepared in the form of planar disks or relatively large diameter (about 1 cm) tubes by conventional ceramic processing methods. However, a larger membrane area per unit volume can be achieved using a hollow fibre geometry in which the external diameter of the fibre is only a few millimetres.

Gas tight perovskite hollow fibres have been traditionally prepared through a wet phase inversion/sintering technique originally described by Liu and Gavalas (Oxygen selective ceramic hollow fibre membranes, J. Membr. Sci., 2005 246 103-108). Generally, the phase inversion process is described as the induction of phase separation in a polymer solution either by a temperature change, immersing the solution in a non-solvent bath (wet), or exposing it to a non-solvent (dry) atmosphere. In more detail, the process described by Liu an Gavalas involves the addition of certain oxide precursor powders (a mixture of barium, strontium, cobalt and iron, nitrates) to a polymer solution (polyethersulfone (PESO dissolved in N-methyl 2-pyrrolidone (NMP)), with stirring for 24 hours. The resulting suspension was subsequently degassed at room temperature and transferred to a reservoir pressurized with nitrogen. Wet spinning of fibres was carried out through a tube-in-orifice spinneret with the emerging fibres being passed through an air gap before being immersed in a water bath to cause gelation of the polymer. After thorough soaking in water, the gelled hollow fibres were dried and heated in a furnace at a suitably high temperature to decompose and remove the polymer. Sintering was then carried out to obtain a gas tight structure. The fibres were subsequently cooled to room temperature. In this production process the role of the polymer is as a binder so that the hollow fibre shape is maintained before and during the sintering process.

With respect to the binder PESf is used because it is stable (its glass transition temperature is above 230° C.), readily soluble in a range of organic solvents and easily applied in the phase inversion processes. The repeat unit in PESf is shown below.

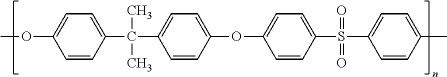

An important property of a perovskite membrane is maximum oxygen flux and desirably this is as high as possible. In the study noted above Liu and Gavalas report a maximum oxygen flux of 3.9 mL/min/cm² at 950° C. and 0.022 atm of average permeate oxygen partial pressure, and this is said to compare favourably with values reported in the literature for tubular membranes formed from the same perovskite material.

In another study however Chen et al. (Further performance of Ba_{0.5}Sr_{0.5}Co_{0.8}Fe_{0.2}O_{3-δ} (BSCF) perovskite membranes for air separation, Ceramics International 2009 35 2455-2461) report an improved oxygen flux for membranes prepared by uni-axial pressing of precursor nitrates to form disc-shaped membranes that are then fired. The oxygen permeation through the membranes was tested at different temperatures and for various oxygen partial pressure gradients. Further improvements in oxygen flux were also observed by reducing the membrane thickness and by surface modification of the membranes. Surface modification involved spraying the membrane surfaces with a slurry including the precursor nitrates followed by drying and firing. The highest oxygen flux reported is 6.0 mL/min/cm² at 900° C.

It would be desirable to provide an alternative process by which perovskite membranes may be produced with suitably high oxygen flux characteristics, whilst retaining a membrane morphology that provides a large surface area per unit volume.

### SUMMARY OF THE INVENTION

Accordingly, the present invention provides a process for producing a ceramic membrane in the form of a hollow fibre, which process comprises:

forming a suspension by mixing inorganic oxide precursor particles with a solution of a polymer binder dissolved in a solvent for the binder;
feeding the suspension through a spinneret to form hollow fibres;
passing the fibres through an air gap and into a coagulant to solidify the fibres;
heating the fibres to remove the polymer binder; and
sintering the fibres to render them gas tight,
wherein the polymer binder is selected so that it may be removed from the fibres by heating without leaving any residual species within the ceramic that will impair the oxygen permeability of the fibres.

In accordance with the present invention it has been found that the nature of the polymer binder used in forming the fibres has an impact on the oxygen permeability of the (finished) fibres. More specifically, it is believed that the presence of certain species in the polymer binder can otherwise lead to the formation of contaminant compounds that are retained within the crystal structure of the sintered ceramic and that can impede (high temperature) transport of oxygen ions through the ceramic and thus reduce oxygen flux. In accordance with the present invention the polymer used as binder is specifically selected with this in mind.

In accordance with the present invention the polymer binder that is used to form the fibres is selected so that (a) it fulfils the necessary functional requirement of serving as a binder so that the fibres may be formed and (b) it may be removed from the fibres by heating without leaving any residual species within the final ceramic structure that will impede the oxygen permeability of the (finished) fibres. In this regard the polymer is generally one that on heating will decompose to gaseous species that are suitably unreactive with respect to components of the ceramic at the prevailing temperature at which heating takes place. Thus, in one embodiment the polymer used as binder is specifically selected to be sulphur-free. It is believed that the presence of sulphur in the polymer can lead to the stoichiometric changes of trivalent or higher-valent cation sites in the resultant ceramic and the formation of metal sulphates within the ceramic. Such compounds alter the crystal structure of the ceramic and adversely influence its oxygen permeability.

This point may be illustrated with reference to perovskites having the formula ABO₃ where A is an alkali metal, alkaline earth metal or rare earth metal (eg. Ba, Sr, La) and B is a transition metal (eg. Fe, Co). Doping of this structure with other metals in either the A or B site, for example in a pattern such as AlA′l-x ByB′l-y O_{δ-8}, leads to distortion of the crystal lattice and the creation of oxygen vacancies. This is believed to impede transport of oxygen ions through the perovskite.

It may be desirable to use a polymer binder that is relatively volatile so that relatively low temperatures may be employed to remove the polymer from the (green) fibres once formed. At low temperatures reaction between binder components and components of the ceramic may be less likely to occur. In this case it may in fact be possible to use a binder that contains potentially detrimental species such as sulphur, provided that the binder can be removed cleanly from the fibres by heating at a temperature at which such species are benign with respect to otherwise reactive components of the ceramic.

In accordance with the present invention it is believed that the stoichiometric changes caused by the sulphur in the polymer binder may form significant species that leads to a reduction in oxygen flux of the fibres due to the presence in the fibres of contaminant non-ionic metal oxides and sulphur-containing compounds. Accordingly, the present invention will be illustrated in more detail with respect to the use of sulphur-free polymer binders. However, the invention should not be considered as being strictly limited to the use and sulphur-free polymer binders bearing in mind the more general principles explained above.

The present invention also provides hollow fibre ceramic membranes formed in accordance with the present invention noting that selection of the binder is an important aspect of the invention.

The present invention also provides a method of improving the oxygen permeability of a hollow fibre ceramic membrane formed by phase inversion using a sulphur-containing polymer as binder, which method comprises forming the fibres by replacing at least a portion of the sulphur-containing binder with a binder that does not leave any residual species in the fibres that will impair the oxygen permeability of the fibres. In accordance with this aspect of the invention, preferably, at least 50%, more preferably at least 75% and more preferably still 100%, if the sulphur-containing binder is replaced.

### DETAILED DISCUSSION OF THE INVENTION

In accordance with the present invention the ceramic hollow fibres are produced by wet phase inversion/sintering using the methodology described above. In a first step of the process a suspension is formed by mixing inorganic oxide precursor particles with a solution of a polymer binder dissolved in a solvent for the binder. The polymer binder is selected as per the principles set out above, noting also that the binder should exhibit other properties to render it useful for fibre formation. For example, the polymer binder should desirably yield green fibres that are ductile and strong. The usefulness of any particular polymer in practice of the invention may be assessed by routine experimentation.

The polymer may be a homopolymer or copolymer. Typically, the polymer has a Tg of from 150 and 250° C. The polymer generally has a molecular weight of from 15,000 to 45,000.

Examples of polymers that may be useful in accordance with the present invention include polyimides, poletherimides, polyacrylonitriles, polyamideimides and poly(vinylidene fluoride).

Polyimide (PI) is thermosetting polymer known for its thermal stability, chemical resistance and superior mechanical properties. Its ability to maintain structural integrity at high temperatures and lack of sulphur in its molecular structure makes it an ideal candidate for use as a polymer binder in the manufacture of ceramic hollow fibres in accordance with the present invention

Polyetherimide (PEI) is an amorphous polymer, known for its high thermal stability and superior strength compared to PESf. It is easily processed by phase inversion techniques and does not introduce contamination into the ceramic hollow fibres like PESf.

Polyacrylonitrile (PAN) is a highly crystalline polymer that has been used in the preparation of ultrafiltration membranes. It can be formed into hollow fibres via traditional phase inversion techniques.

Polyamideimide (PAI) is a high performance, amorphous polymer with exceptional thermal, chemical and mechanical properties. Its ability to maintain structural integrity at high temperatures and lack of sulphur in its molecular structure makes it an ideal candidate for use as a binder in the manufacture of ceramic hollow fibres in accordance with the present invention.

Poly(vinylidene fluoride) (PVDF) is a semi-crystalline polymer that is widely used in the manufacture of ultrafiltration membranes due to its high chemical resistance. It is flexible and has a melting point around 140° C.

Initially, the selected polymer is dissolved in a suitable solvent and one skilled in the art would be aware of possible solvents to use. The solvent should be a good solvent for the polymer and should be capable of providing a stable suspension of the inorganic oxide precursor particles. Additionally, the solvent should be compatible with the fibre-forming methodology and it should not contribute any species that are likely to cause contaminant issues in the finished fibres as noted above with respect to the polymer binder. Candidate solvents include N-methyl 2-pyrrolidone (this has found to be generally useful, especially for polymers such as polyetherimide), N,N-dimethylacetamide, N,N-dimethylformamide, gamma-butyrolactone, glycol ethers, glycol esters, dimethyl sulfoxide, tetrahydrofuran, dichloromethane, chloroform, dioxane, methyl ethyl ketone, acetone and acetonitrile. It may also be possible to use non-polar solvents, such as toluene, hexane, benzene and the like.

The inorganic oxide precursor particles comprise a mixture of metal compounds, typically nitrates, that on sintering will form a ceramic structure containing metal oxides having oxygen ion transport functionality. Typically, the ceramic will have a perovskite, fluorite, brownmillerite or aurivillite structure, and dual phase materials containing ceramics and metal (for example silver, gold, platinum, palladium and the like).

Perovskites formed according to the invention typically have the ABO_{3-δ} structure, where A is a divalent cation and B is a trivalent or higher-valent cation and δ is from 0.001 to 1.5, and the inorganic oxide precursor particles are selected accordingly. In embodiments of the present invention it is preferred to form a ceramic having a perovskite structure comprising the elements Ba, Sr, Co, Fe, and O; Ba, Sr, Fe, Zn and O; Ba, Co, Fe, Zr and O; La, Sr, Co, Fe and O; Ba, Bi, Sc, Co and O; Ba, Sr, Co, Fe, Y and O; or Ba, Sr, Co, Cu and O. Preferably, the perovskite is BSCF. Such perovskites may be formed using a suitable mixture of metal nitrates as the inorganic oxide precursor.

Fluorites used according to the invention typically have the A_{δ}B_{1-δ}O_{2-δ} and A_{2δ}B_{2-2δ}O₃ structure, where A, B and δ are as defined above. In the fluorite mixtures of different cations A and/or cations B can be present.

Brownmillerites used according to the invention typically have the A₂B₂O_{5-δ} structure, where A, B and δ are as defined above. In the brownmillerites mixtures of different cations A and/or cations B can be present

Cations B can preferably occur in a plurality of oxidation states. However, part or all cations of type B can also be trivalent or higher-valent cations having a constant oxidation state. Typically, the present invention uses oxide ceramics which contain cations of type A selected from among cations of main group II, transition group I, transition group II, the lanthanide group and mixtures of these cations, preferably from among Mg²⁺, Ca²⁺, Sr²⁺, Cu²⁺, Ag²⁺, Zn²⁺, Cd²⁺ and the lanthanides.

Oxide ceramics may also be used that contain cations of type B selected from among cations of groups IIIB to VIIIB of the Periodic Table and the lanthanide group, the metals of main groups III to V and mixtures of these cations, for example from among Fe³⁺, Fe⁴⁺, Ti³⁺, Ti⁴⁺, Zr³⁺, Zr⁴⁺, Ce³⁺, Ce⁴⁺, Mn³⁺, Mn⁴⁺, Co²⁺, Co³⁺, Nd³⁺, Nd⁴⁺, Gd³⁺, Gd⁴⁺, Sm³⁺, Sm⁴⁺, Dy³⁺, Dy⁴⁺, Ga³⁺, Yb³⁺, Al³⁺, Bi⁴⁺ and mixtures of these cations.

Further oxide ceramics which may be used contain cations of type B selected from among Sn²⁺, Pb²⁺, Ni²⁺, Pd²⁺, lanthanides and mixtures of these cations.

Aurivillites used according to the invention typically comprise the structural element (Bi₂O₂) (VO_{3.5[ ]0.5}) or related structural elements, where [ ] is an oxygen vacancy.

The inorganic oxide precursor particles should be small enough to provide a relatively uniform dispersion of the particles in the polymer solution from which the fibres will be formed. The particles should also be small enough to obtain a relatively uniform distribution of the inorganic particles in the precursor hollow fibre. The grain size is selected such that at least a highly dense layer in the unsintered precursor hollow fibre is achieved.

Generally speaking, the median particle size should be less than about 4 microns, preferably less than 2 microns, and more preferably less than 1 micron. It has been found that a more defect-free hollow fibre can be produced when the average particle size is less than about 1 micron and the particle size distribution is narrow. Desirably, the precursor particles exhibit a narrow distribution in particle size, such as at least 99% by volume of the inorganic particles have a particle size between 0.1-1.0 microns.

An especially optimal particle size distribution is one in which no particles exceeding 3 microns in size and in which there are two groups of similarly sized particles, i.e., large particles and small particles. This is desirable for achieving a relatively high degree of uniformity of packing and enhanced green density because the smaller sized particles fit in the otherwise empty spaces in between the larger sized particles.

The precursor particles may be commercially available, synthesised and/or produced by size reduction of larger-sized particles by known milling techniques.

The suspension can be formed by mixing the individual components in any suitable order. For example, the precursor particles, polymer binder and solvent may be mixed together. It is usually preferred however to dissolve the polymer in the solvent followed by addition of the precursor particles with mixing. Elevated temperatures may be applied to facilitate dissolution of the polymer in the solvent.

Typically, the suspension comprises 50-75% by weight precursor particles, 5-15% by weight polymer binder and the balance solvent. The weight ratio of precursor particles to polymer binder is generally from about 5:1 to about 15:1. Additives such as plasticizers and dispersants may also be used provided that they do not adversely influence the properties of the finished fibres. The role of the EDTA and citrate method is to form and stabilise the metal ions in the solution.

After having been formed the suspension is feed through a spinneret. The design of the spinneret is conventional. The spinneret could have an outer diameter (OD) and inner diameter (ID) of 10 mm and 0.2 mm, and possibly 5 mm (OD) and 0.2 mm, and preferably 2.5 mm (OD) and 0.5 mm (ID), respectively. After leaving the spinneret the fibre passes through an air gap and into a coagulant bath. In practice the fibre is drawn into the bath, for example by winding on a suitable take-up roll. The rate of draw can be used to modify the diameter of the fibre prior to entry into the bath. On entering the coagulant bath the polymeric solution component of the fibre undergoes phase inversion causing the fibre to solidify. The coagulant is typically water and/or a polar organic solvent such as alcohol, or the like. The diameter of the drawn fibre is typically from 200 to 1000 microns.

The next step in the process involves drying the fibres by heating in an oven, for example at a temperature of 150° C. Subsequently, the fibres are heated to decompose and remove the polymer binder. Heat is usually applied gradually in this step. By way of illustration the temperature may be raised at a rate of 3° C./min to a temperature of 750-850° C. and maintained for a number of hours. The extent and rate of decomposition and removal of the polymer can be measured experimentally to optimise the temperature regime in this part of the process.

The fibres are then sintered at elevated temperature. Sintering is intended to lead to formation of a gas tight structure. Generally, sintering takes place at a temperature of at least 1000° C. for a number of hours. Again, this part of the process can be optimised by experimentation.

### DISCUSSION OF DRAWINGS

The present invention is illustrated with reference to the accompanying non-limiting drawings in which:

FIG. 1 is a schematic illustrating an experimental arrangement used for determining oxygen permeation of a ceramic hollow fibre; and

FIG. 2 is a plot of oxygen permeability of BSCF hollow fibre prepared with two types of polymer binder, PESF and PEI, with Argon sweep gas flow rate standardised at 150 ml/min.cm².

The following non-limiting examples illustrate embodiments of the present invention.

### EXAMPLE 1

BSCF powders used for the hollow fibre were prepared using a combined EDTA-citrate complexation method. The nitrates of barium, strontium, cobalt and iron were obtained in powder form with purity greater that 99.9%. The BSCF powders were calcined in air at 500° C. for 4 hours and milled to obtain a particle size of less than 3 μm. The BSCF powders were added to a mixture of NMP and polyetherimide (PEI) [SABIC Innovative Plastics] (mass ratio 6:1:5) and stirred for 24 hours to ensure a uniform mixture. 0.5% to 1% by mass polyvinylpyrrolidinone (PVP) [Sigma-Aldrich], with a molecular weight 1,300,000, was added to adjust the viscosity of the mixture to 5.2 Pa·s. To form the BSCF-NMP-PEI mixture into the required hollow fibre geometry, a tube-in-orifice spinneret with orifice diameter/inner diameter of 2.5 mm/0.8 mm, was used. Water was used as a coagulant when the mixture was extruded from the spinneret. The extruded hollow fibres were dried, cut into short lengths and sintered at 1050° C. for 4 hours to obtain gas tight membranes. Before sintering the hollow fibre is often referred to as ‘green’, in the sense that it still contains the polymeric binder.

The oxygen permeability of the fibres is tested according to the following procedure.

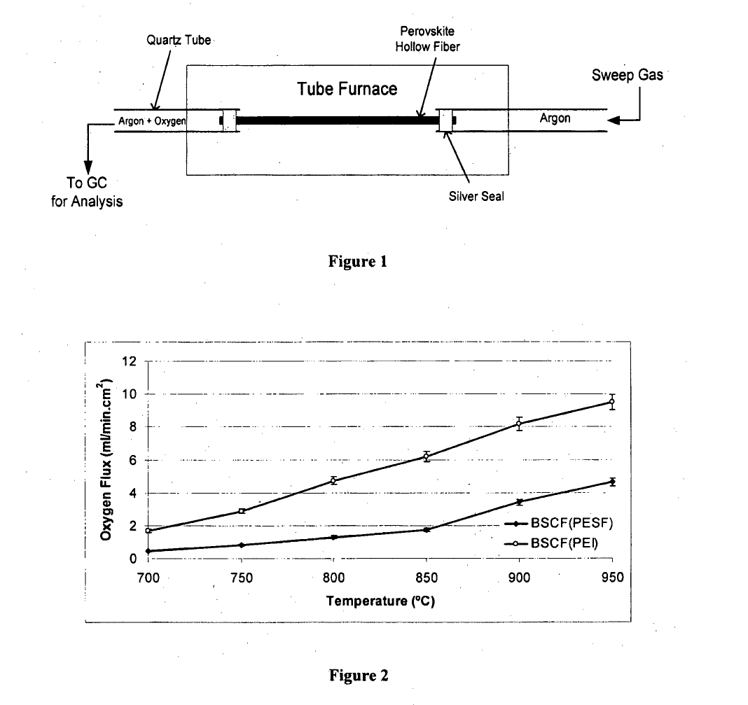

Perovskite hollow fibres with lengths between 50 and 70 mm were suspended in a split hinge tube furnace with a constant temperature zone of 10 cm. Quartz tubes were attached to both ends of the hollow fibres and sealed with a silver-based sealant. The membrane seals were gas tight as nitrogen was not detected when the permeate stream was tested using a gas chromatagraph (GC). A schematic of the experimental setup is shown in FIG. 1. Permeation experiments were conducted by passing an argon sweep gas through the permeate stream of a perovskite hollow fibre and varying the temperature of the tube furnace. For this work, argon was used as a sweep gas to enable oxygen permeation to occur at temperatures between 550-950° C. A quartz tube is used to deliver argon to the hollow fibre and for transporting the output (argon and oxygen) from the hollow fibre. The quarts tubes are attached to respective ends of the hollow fibre using silver seals. For ease of comparison, all experiments were conducted with the sweep gas rate maintained at 150 ml/(min.cm²), where the area refers to the membrane inner surface area. The maximum temperature was dictated by the melting temperature of the silver seals. The argon/oxygen permeate stream was fed directly from the perovskite fibre to a gas chromatograph (Shimadzu GC-2014) fitted with a 5A molecular sieve column for analysis. The permeate flowrate was measured by a bubble flow meter downstream of the fibre.

The membrane area and oxygen permeation was calculated using equations 1 and 2, respectively:

$$\begin{matrix}S = \frac{π L ( {D}_{o} - {D}_{i} )}{ln ( {D}_{o} / {D}_{i} )} & ( Equation 1 ) \\ {O}_{2} ( Permeation ) = \frac{{F}_{permeate} {C}_{oxygen}}{S} & ( Equation 2 )\end{matrix}$$

where L, Do and Di are length, outside diameter and inside diameter of the fibre in mm, Fₚₑᵣₘₑₐₜₑ and C_{oxygen} are flowrate (ml/min) of permeate and oxygen percentage respectively.

The oxygen permeability for the BSCF fibres was forced to be 9.5 mL/min/cm².

The experiment was repeated to prepare the perovskites BSCC (Ba 0.5 Sr 0.5 Co 0.8 Cu 0.2 0_{3-δ}) and BBSC (Ba Bi 0.5 Sc 0.1 Co 0.85 0_{3-δ}) as hollow fibre membranes. The oxygen permeability for the BSCC membrane was found to be 13.5 mL/min/cm² and 12 mL/min/cm² for the BBSC membrane.

The oxygen permeability values that have been achieved in accordance with the present invention are believed to be higher than those reported in the literature for equivalent ceramic materials using a sulphur-containing binder to prepare the fibres.

### EXAMPLE 2

The general methodology of Example 1 was followed to prepare a BSCF hollow fibre ceramic membrane. However, the binder used was PESf.

Raman spectroscopy revealed Co₃O₄ which was not incorporated in the BSCF crystal phase and XPS detected the presence of BaSO₄ in the samples synthesized with PESf. However, these two compounds do not appear to be present for the samples prepared with PEI as binder. To explain this phenomenon, the reactions in Equations 1 and 2 may explain the results obtained in this work:

$$0.5 BaO + 0.5 SrO + 0.8 {Co}_{3} {O}_{4} + 0.2 FeO {}^{> 1000 ° C .} {Ba}_{0.5} {Sr}_{0.5} {Co}_{0.8} {Fe}_{0.2} {O}_{3 - δ} \qquad Equation 1$$

The oxides of barium, strontium, cobalt and iron (synthesized from nitrates and calcined at 250° C.) reacted with PEI binder resulted in the formation of Ba_{0.5}Sr_{0.5}Co_{0.8}Fe_{0.2}O_{3-δ} (represented by the reaction in Equation 1).

$${Y BaSO}_{4} + ( 0.5 - Y ) BaO + 0.5 SrO + 0.8 {Co}_{3} {O}_{4} + 0.2 FeO {}^{> 1000 ° C .} {Y BaSO}_{4} + X {Co}_{3} {O}_{4} + {Ba}_{0.5 - Y} {Sr}_{0.5} {Co}_{0.8 - X} {Fe}_{0.2} {O}_{3 - δ} \qquad Equation 2$$

The oxides of barium, strontium, cobalt and iron (synthesized from nitrates and calcined at 250° C.) reacted with PESf resulted in the formation of a different composition Ba_{(0.5-x)}Sr_{0.5}Co_{(0.8-y)}Fe_{0.2}O_{3-δ}, (represented by the reaction in Equation 2 where X and Y represent the concentration of BaSO₄ and Co₃O₄).

Due to the presence of sulphur in the polymer binder, Ba may preferentially react to form the stable salt BaSO₄ (represented by Y in Equation 2), thus varying the barium oxide to the cobalt oxide stoichiometry available to form BSCF perovskite structures. Reactions of barium oxide with sulphur compounds are known to occur at temperatures between 250 to 450° C., which is evidenced by BaSO₄ detected by Raman spectroscopy.

Once the sample is sintered at temperatures in excess of 1000° C. as shown in Equation 2, the remaining oxides form a perovskite crystal of general formula ABO₃. Since there is more trivalent and/or higher valent cations in the B-site than the bivalent cation in the A-site, an amount of Co₃O₄ is left unreacted to compensate for the shortage of Ba. This ensures that the perovskite has the correct proportion of elements to form into a cubic structure. The perovskite membrane fabricated with PESf has a different crystal formula of Ba_{(0.5-Y)}Sr_{0.5}Co_{(0.8-Y)}Fe_{0.2}O_{3-δ} (represented by Equation 2), instead of Ba_{0.5}Sr_{0.5}Co_{0.8}Fe_{0.2}O_{3-δ} (perovskite membrane fabricated with PEI represented by Equation 1). In addition, the PESf derived membranes may have formed domains of non-ionic conductive Co₃O₄ and BaSO₄ which are interspaced within the perovskite structure. As a consequence, the altered crystal composition of the perovskite and presence of Co₃O₄ and BaSO₄ reduced the oxygen permeation of the membrane.

### EXAMPLE 3

Disk membranes were fabricated with similar thickness and density to reduce error and to allow for easy comparison of oxygen permeation results. A control using pure BSCF (i.e. without any binder) was tested to provide a baseline for comparison purposes. Pure BSCF disk membranes can be easily produced by pressing powders into pellets. However, hollow fibres require a polymer binder which cannot be achieved by using pure BSCF. The membrane fabricated without PESf showed oxygen flux consistently higher (at least 45%) at the tested temperatures than the membranes prepared with PESf. There were minor differences in oxygen fluxes between the pure and PEI derived BSCF membranes. However, the differences were within experimental error and could be attributed to minor changes during the preparation, minor differences in membrane thickness or sintering of different batches of membranes. Nevertheless, the key findings of this work validate the postulation that unincorporated cobalt oxides and sulphur compounds formed during sintering of BSCF membranes prepared using a sulphur containing binder, detrimentally affect oxygen permeation.

### EXAMPLE 4

Permeation results show greater oxygen permeation was obtained from the BSCF hollow fibre made with PEI instead of PESf (see FIG. 2). Of great interest, the BSCF-PEI hollow fibre delivered an appreciable oxygen flux of 1.69 ml min⁻¹ cm⁻² at 700° C., which is similar to the same flux of the BSCF-PESf membrane at 850° C. The difference in oxygen permeation was much more pronounced at 850° C., where the BSCF-PEI membrane produced 6.19 ml min⁻¹ cm⁻², while the BSCF-PESf membrane only managed 1.74 ml min⁻¹ cm⁻².

The highest temperature setting of 950° C. continued the trend of higher permeation values for the BSCF-PEI hollow fibre membrane, reaching 9.50 ml min⁻¹ cm⁻², an improvement of 105% over the BSCF-PESf hollow fibre. These results exceed the best oxygen permeation results published in the literature. The oxygen permeation results for BSCF-PEI hollow fibres further validate the hypothesis that unincorporated cobalt oxides and sulphur compounds alters the perovskite composition in the BSCF-PESf sample. Similarly, the formation of different BSCF structures interrupted the pathways available for the diffusion of oxygen ions through the membrane, thus reducing the overall oxygen flux. The use of sulphur-free polymer, PEI, avoids the non incorporation of trivalent or higher-valent cations (Co₃O₄) and formation of BaSO₄, resulting in a purer perovskite structure and improved oxygen permeation.

Many modifications will be apparent to those skilled in the art without departing from the scope of the present invention

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The claims defining the invention are as follows:

1. A process for producing a ceramic membrane in the form of a hollow fibre, which process comprises:
forming a suspension by mixing inorganic oxide precursor particles with a solution of a polymer binder dissolved in a solvent for the binder;
feeding the suspension through a spinneret to form hollow fibres;
passing the fibres through an air gap and into a coagulant to solidify the fibres;
heating the fibres to remove the polymer binder; and
sintering the fibres to render them gas tight,
wherein the polymer binder is selected so that it may be removed from the fibres by heating without leaving any residual species within the ceramic that will impair the oxygen permeability of the fibres.

2. The process of claim 1, wherein the polymer binder is sulphur-free.

3. The process of claim 1, wherein the polymer binder has a Tg of from 150 to 250° C.

4. The process of claim 1, wherein the polymer binder has a molecular weight of from 15,000 to 45,000.

5. The process of claim 1, wherein the polymer binder is selected from the group consisting of polyimides, poletherimides, polyacrylonitriles, polyamideimides and poly(vinylidene fluoride).

6. The process of claim 1, wherein the solvent is selected from the group consisting of N-methyl 2-pyrrolidone, N,N-dimethylacetamide, N,N-dimethylformamide, gamma-butyrolactone, glycol ethers, glycol esters, dimethyl sulfoxide, tetrahydrofuran, dichloromethane, chloroform, dioxane, methyl ethyl ketone, acetone, acetonitrile, toluene, hexane and benzene.

7. The process of claim 1, wherein the inorganic oxide precursor particles comprise a mixture of metal compounds that on sintering will form a ceramic structure containing metal oxides having oxygen ion transport functionality.

8. The process of claim 1, wherein the ceramic is selected from the group consisting of perovskite, fluorite, brownmillerite and aurivillite structures, and dual phase materials containing ceramics and metal.

9. The process of claim 1, wherein the inorganic oxide precursor particles have a median particle size less than about 4 microns

10. The process of claim 1, wherein the inorganic oxide precursor particles have a particle size distribution such that no particles exceed 3 microns in size and such that there are two groups of similarly sized particles

11. The process of claim 10, wherein the inorganic oxide precursor particles have an average particle size less than 1 μm.

12. The process of claim 1, wherein the suspension comprises 50-75% by weight inorganic oxide precursor particles, 5-15% by weight polymer binder and the balance solvent.

13. The process of claim 1, wherein the weight ratio of inorganic oxide precursor particles to polymer binder is from about 5:1 to about 15:1.

14. A hollow fibre ceramic membrane produced by the process of claim 1.

15. A method of improving the oxygen permeability of a hollow fibre ceramic membrane formed by phase inversion using a sulphur-containing polymer as binder, which method comprises forming the fibres by replacing at least a portion of the sulphur-containing binder with a binder that does not leave any residual species in the fibres that will impair the oxygen permeability of the fibres.
